(19) United States
(12) Patent Application Publication
(10) Pub. No.: US 2017/0055450 A1
(43) Pub. Date: Mar. 2, 2017

(54) BAT TUBE SUPPORT ARM DESIGN FOR A PICK-UP REEL OF A HARVESTER

(71) Applicant: HCC, Inc., Mendota, IL (US)

(72) Inventor: Edward Patrick Jasper, Mendota, IL (US)

(21) Appl. No.: 15/245,362

(22) Filed: Aug. 24, 2016

Related U.S. Application Data
(60) Provisional application No. 62/212,141, filed on Aug. 31, 2015.

(51) Int. Cl. A01D 57/02

(52) U.S. Cl. CPC A01D 57/02

(57) ABSTRACT

A bat tube support arm design for use with a pick-up reel of a harvester. The design connects tangentially, rather than radially, to a center support tube of the pick-up reel. The design comprises a plurality of structures, each of which supports a plurality of bat tubes. The structures collectively share the drive load of the pick-up reel, thereby allowing lighter materials to be used and providing an overall design which is stronger than conventional designs. The number of fasteners is reduced or minimized, thereby also reducing the labor required to assemble. The structures may comprise two triangular or square structures, wherein a first structure connects tangentially to the center support tube, and a second structure connects to the first structure.

### RELATED APPLICATION (PRIORITY CLAIM)

This application claims the benefit of U.S. Provisional Application Ser. No. 62/212,141, filed Aug. 31, 2015, which is hereby incorporated herein by reference in its entirety.

### BACKGROUND

The present invention generally relates to harvester pick up reels, and more specifically relates to a bat tube support arm design which is stronger than typical designs, and which allows for lighter materials to be used.

A typical harvester includes a pick-up reel. The pick-up reel includes a plurality of bat tubes, and tines are arranged along each of the bat tubes. When the harvester operates, the pick-up reel rotates, causing the tines to engage the crop and pull the crop into the harvester.

Typically, each bat tube is supported by a bat tube support arm, and each bat tube support arm is connected to a center support tube. As such, typical pick-up reel bat tube support arm designs generally use multiple, similar parts which are all fastened directly to the center support tube, and extend radially from a centerline of that center support tube to their connection with the bat tubes. In some cases, the bat tube support arms are also connected to each other, to help share the drive load of the reel, thereby adding to the number of fasteners, assembly labor, and material required. In cases where the bat tube support arms are not fastened to each other, the bat tube support arms must be provided as a heavier material in order to withstand the drive load of the reel during operation.

### SUMMARY

An object of an embodiment of the present invention is to provide a bat tube support arm design for use with a pick-up reel of a harvester, where the design is both strong and allows for the use of light materials.

Briefly, an embodiment of the present invention provides a bat tube support arm design for use with a pick-up reel of a harvester, where the bat tube support arm design connects tangentially, rather than radially, to a center support tube of the pick-up reel. The bat tube support arm design comprises a first structure which connects to a plurality of bat tubes, as well as connects tangentially to the center support tube of the pick-up reel. A second structure connects to the first structure, and is also connected to a plurality of bat tubes. Preferably, each structure is either triangular (in a 6-bat system) or square (in an 8-bat system). Regardless, the two structures collectively share the drive load of the pick-up reel, thereby allowing lighter materials to be used and providing an overall design which is stronger than conventional designs. The number of fasteners is reduced or minimized, thereby also reducing the labor required to assemble.

### BRIEF DESCRIPTION OF THE DRAWINGS

The organization and manner of the structure and operation of the invention, together with further objects and advantages thereof, may best be understood by reference to the following description taken in connection with the accompanying drawings wherein like reference numerals identify like elements in which:

FIG. 1 is a side view of a conventional harvester, which comprises a pick-up reel that utilizes bat tubes supported by bat tube support arms in a conventional bat tube support arm design; and

FIG. 2 illustrates a portion of a pick-up reel which incorporates a bat tube support design which is in accordance with an embodiment of the present invention; and

FIG. 3 is close up view of the bat tube support design shown in FIG. 2.

### DESCRIPTION OF ILLUSTRATED EMBODIMENT

While this invention may be susceptible to embodiment in different forms, there is shown in the drawings and will be described herein in detail, a specific embodiment with the understanding that the present disclosure is to be considered an exemplification of the principles of the invention, and is not intended to limit the invention to that as illustrated.

An embodiment of the present invention provides a bat tube support arm design for use with a pick-up reel of a harvester, where the bat tube support arm design connects tangentially, rather than radially, to a center support tube of the pick-up reel.

First, a conventional harvester which includes bat tubes supported in a conventional way will be described, and then a bat tube support arm design in accordance with an embodiment of the present invention will be described.

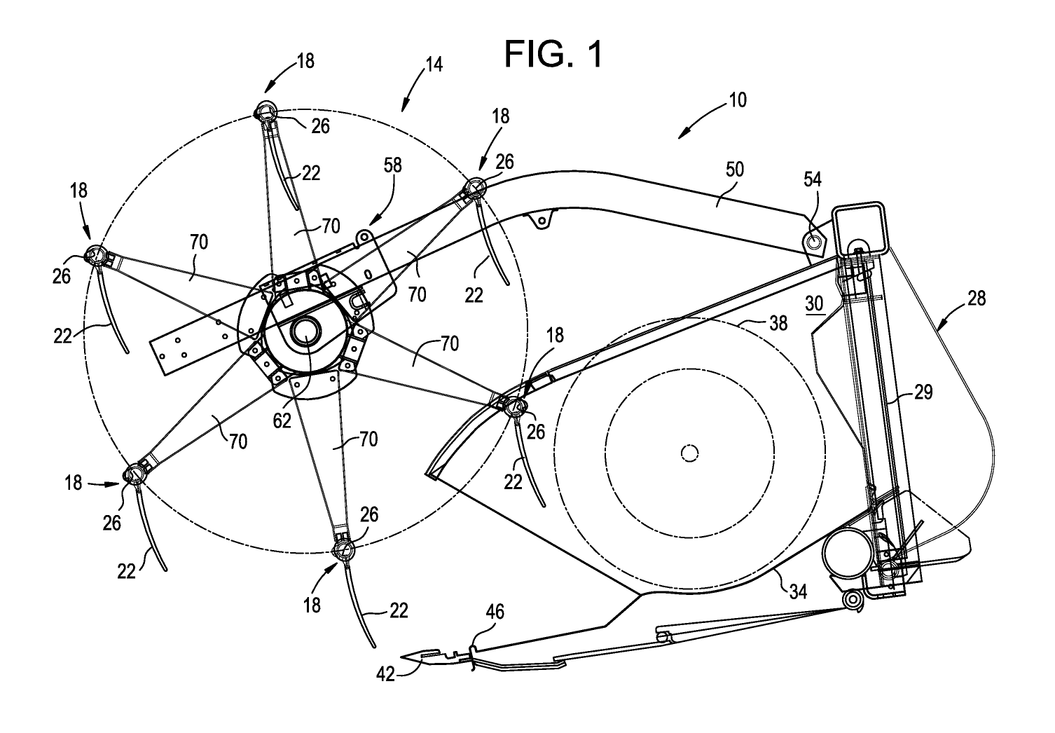

FIG. 1 is a side view of a conventional harvester 10 utilizing a pick-up reel 14. The harvester 10 shown in FIG. 1 includes a non-flip reel, i.e, a pick-up reel 14 that provides for standard tine action (i.e., that the tines 22 do not flip during harvesting), but embodiments of the present invention can be utilized with flip-type reels as well.

The harvester 10 includes the pick-up reel 14, and a harvester tine and bat tube assembly 18. The assembly 18 includes harvester tines 22 and bat tubes 26. The harvester 10 also includes a harvester platform 28 including a platform frame 29, supported for movement over ground, and side and rear wall 30. A floor 34 extends between the opposite side walls 30, and a transverse crop converging auger 38 is rotatably supported above the floor 34 and forward of the rear wall 30 (unless the harvester is provided as being a draper header type of harvester, in which case cross belts would be utilized instead of an auger). A transverse cutter bar 42 is mounted along the forward edge of the floor 34, and an upright crop dam 46 is supported between the cutter bar 42 and the floor 34.

The pick-up reel 14 generally spans the width of the platform 28, forward of the auger 38 and above the cutter bar 42. The pick-up reel 14 is connected to the platform 28 by a pair of reel support arms 50 (one shown), which support the pick-up reel 14 on the frame 29. In the construction illustrated in FIG. 1, the support arms 50 are pivotally connected to the frame 29 at pivot points 54. The support arms 50 are generally above the sidewalls 30 of the platform 28. Preferably, the support arms 50 are selectively vertically adjustable by a pair of cylinders (not shown) connected between the support arms 50 and the sidewalls 30.

A movable support structure 58 is supported at the forward end of each support arm 50. The support structures 58 are generally slidable between forward and rearward positions on the support arm 50, and their movement is controlled by a pair of cylinders (not shown). The support arms 50 and the support structures 58 are adjustably positioned to adjust the position of the pick-up reel 14 relative to the platform 28.

A tubular reel shaft 62 is journalled by and extends between the support structures 58. The shaft 62 is rotatable relative to the support structures 58 about its axis, and a plurality of arms 70 (six in the illustrated construction) radially extend from a center support tube 63, which is coaxial with the shaft 62.

Bat tubes 26 are journalled in the outer ends of the arms 70. The bat tubes 26 are rotatable with the associated arms 70 and, in the illustrated construction, are rotatable relative to the associated arms 70. The bat tubes 26 span the width of the pick-up reel 14 and are generally parallel to and radially-spaced from the center support tube 63. A plurality of harvester tines 22 are connected to each bat tube 26 for movement with the bat tube 26 (in the illustrated construction, for rotation relative to the shaft 62 and relative to the associated arms 70).

The above description regarding FIG. 1 was merely provided to explain one possible environment in which the present invention may exist, and should not be considered to be limiting in any way, as the present invention can be employed with pick-up reels and harvesters that are very different from that which is illustrated in FIG. 1.

As shown in FIG. 1, a typical manner in which bat tubes are supported is via support arms 70 which are connected to, and extend radially from, the center support tube 63 of the pick-up reel 14. As shown, such support arms 70 are often also connected to each other, such as via connecting members 71.

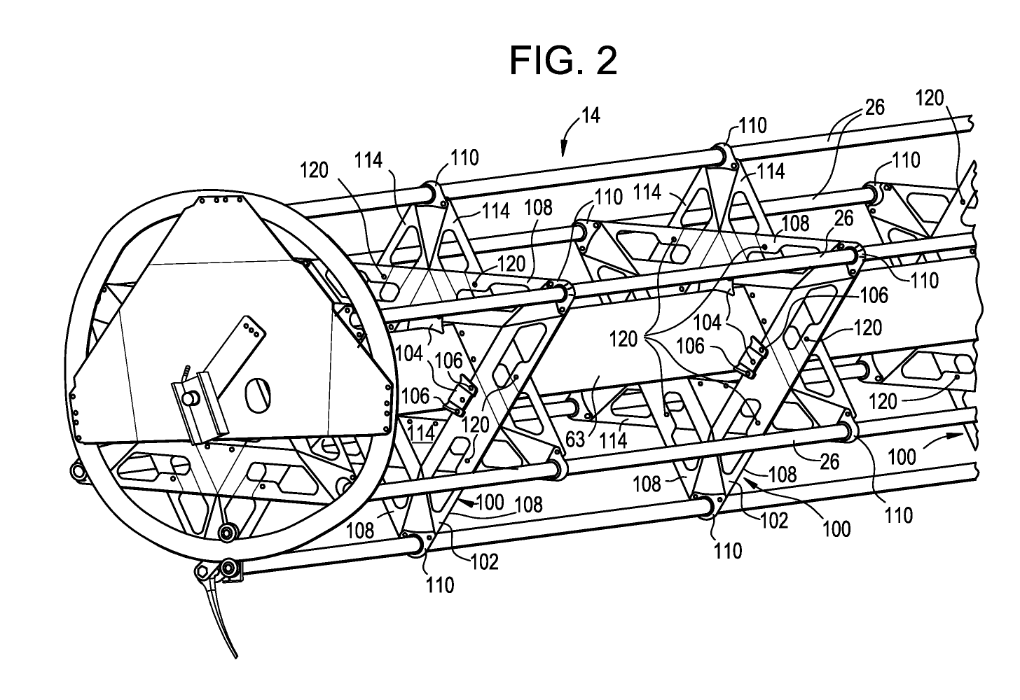

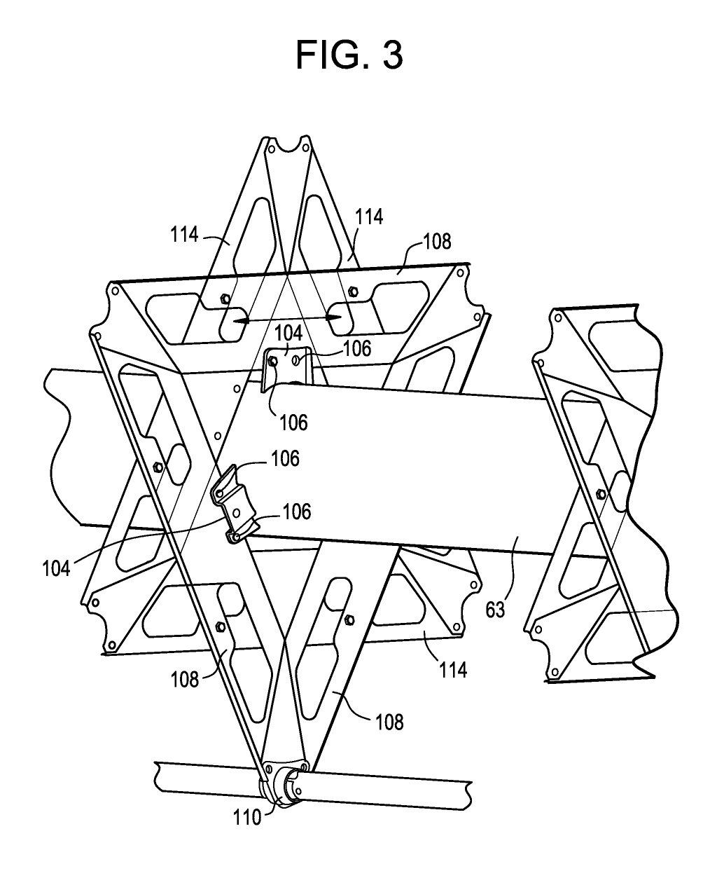

An embodiment of the present invention provides a bat support arm design which is configured differently. The design can be seen in both FIGS. 2 and 3, and is identified generally with reference numeral 100. As shown in FIG. 2, preferably the design repeats itself every so often going down along the length of the center support tube 63 of the pick-up reel 14.

As shown in FIGS. 2 and 3, the design 100 connects tangentially, rather than radially, to the center support tube 63 of the pick-up reel 14. The bat tube support arm design 100 comprises a first sub-assembly or structure 102 which connects to a plurality of the bat tubes 26, as well as connects tangentially to the center support tube 63 of the pick-up reel 14, such as via brackets 104. Specifically, the brackets 104 may be welded, or otherwise connected, to the center support tube 63, and the structure 102 may be connected to the brackets 104 via fasteners 106. Preferably, the structure 102 is comprising three interconnected arms 108. Alternatively, the structure 102 could be, for example, square and have four interconnected arms (such as in an 8-bat system), or have some other shape or comprise some other number of arms. Preferably, each arm 108 is tangential to the center support tube 63, and each end of each of the arms 108 connects to a bat tube 26, such as via a bearing 110 (only one bat tube 26 and bearing 110 is shown in FIG. 3, for simplicity). As such, as shown in FIG. 2, each arm 108 supports two bat tubes 26, one at each end of the arm 108. Preferably, the bat tubes 26 are supported such that they can rotate about their axes. Preferably, each arm 108 of the first structure 102 is connected tangentially to the center support tube 63 via, for example, a bracket such as bracket 104 shown in FIGS. 2 and 3.

Preferably, a second sub-assembly or structure 112 connects to the first structure 102, and is structured quite similarly to the first structure 102 in that it is either triangular (in a 6-bat system) or square (in an 8-bat system), comprised of a plurality of arms 114 (each of which is preferably tangential to the center support tube 63), and supports a bat tube 26 at each end, such as via bearings 110. Again, preferably the bat tubes 26 are supported such that they can rotate about their axes.

Preferably, the second structure 112 is connected to the first structure 102, such as via fasteners 120. Specifically, preferably two fasteners per arm are used, but a single fastener can be used as well. While the second structure 112 is preferably not connected to the center support tube 63 like the first structure 102 is, it very well could be. Regardless, the two structures 102, 112 collectively share the drive load of the pick-up reel 14, thereby allowing lighter materials to be used and providing an overall design which is stronger than conventional designs. The number of fasteners is also preferably reduced or minimized, thereby also reducing the labor required to assemble.

While the two structures 102, 112 are described as being two interconnected triangular or square shaped sub-assemblies (each comprising a plurality of reel bat support arms which are tangential to a center support tube of the pick-up reel), other shapes are possible. Additionally, more than two interconnected sub-assemblies or structures can be provided. Regardless of how many sub-assemblies or structures are provided, or what shape they take, preferably the connection to the center support tube 63 is a tangential connection rather than a radial connection, and the sub-assemblies or structures work to share the load of the reel as the reel operates moving crop into the harvester. By sharing the drive load, lighter materials can be used, the number of fasteners can reduced, and overall assembly can be simplified.

While a specific embodiment of the invention has been shown and described, it is envisioned that those skilled in the art may devise various modifications without departing from the spirit and scope of the present invention.

What is clamed is:

1. A bat tube support arm design configured for use with a pick-up reel of a harvester, wherein the bat tube support arm design is configured to connect tangentially to a center support tube of the pick-up reel, said bat tube support arm design comprising a first structure which is connected to a plurality of the bat tubes, as well as is configured to connect tangentially to the center support tube of the pick-up reel.

2. The bat tube support arm design as recited in claim 1, wherein the first structure is at least one of triangular and square.

3. The bat tube support arm design as recited in claim 1, wherein the first structure comprises a plurality of interconnected arms.

4. The bat tube support arm design as recited in claim 1, further comprising brackets which connect the first structure tangentially to the center support tube of the pick-up reel.

5. The bat tube support arm design as recited in claim 4, wherein the brackets are welded to the center support tube.

6. The bat tube support arm design as recited in claim 5, wherein the first structure is connected to the brackets via fasteners.

7. The bat tube support arm design as recited in claim 1, wherein the first structure comprises a plurality of interconnected arms, wherein each of the arms is connected to one of said bat tubes via a bearing, wherein the bat tubes are supported such that the bat tubes are rotatable about their axes.

8. The bat tube support arm design as recited in claim 1, further comprising a second structure which is connected to the first structure, wherein the second structure is also connected to a plurality of the bat tubes.

9. The bat tube support arm design as recited in claim 8, wherein each of the first and second structures is at least one of triangular and square.

10. The bat tube support arm design as recited in claim 8, wherein the first and second structures collectively share a drive load of the pick-up reel.

11. The bat tube support arm design as recited in claim 8, wherein each of the first and second structures comprise a plurality of interconnected arms.

12. The bat tube support arm design as recited in claim 8, wherein the design repeats itself every so often along a length of the center support tube of the pick-up reel.

13. The bat tube support arm design as recited in claim 8, further comprising brackets which connect the first structure tangentially to the center support tube of the pick-up reel.

14. The bat tube support arm design as recited in claim 13, wherein the brackets are welded to the center support tube.

15. The bat tube support arm design as recited in claim 11, wherein each arm is tangential to the center support tube, wherein each arm is connected to one of said bat tubes via a bearing, and wherein the bat tubes are supported such that the bat tubes are rotatable about their axes.
